(19) United States
(12) Patent Application Publication
(10) Pub. No.: US 2019/0268288 A1
(43) Pub. Date: Aug. 29, 2019

(54) GENERATING CONVERSATIONAL NODES FOR A SYSTEM FUNCTION

(71) Applicant: SAP SE, Walldorf (DE)

(72) Inventors: Piyush Chandra, Belmont, CA (US); Sajid Saiyed, Cupertino, CA (US)

(21) Appl. No.: 15/908,621

(22) Filed: Feb. 28, 2018

(51) Int. Cl. H04L 12/58; G06F 9/54

(52) U.S. Cl. CPC H04L 51/02; H04L 67/20; G06F 9/541

(57) ABSTRACT

Systems and methods are provided for analyzing a process flow file comprising steps for a system function to determine each step in the process of the system function, and generating a start node for a conversational flow for the system function. For each step in the process flow file, the system and methods further provide for generating nodes in the conversational flow for the system function by determining at least one parameter for the step, generating a branch in the conversational flow for the at least one parameter including a condition node for the at least one parameter, generating an application programming interface (API) node for the step, the API node to call a function using the at least one parameter, and generating at least one branch comprising a message node for the response returned from the function called via the API node.

### BACKGROUND

Chatbots are used in a variety of scenarios today within human resource systems. eCommerce, purchase and inventory systems, and so forth. Chatbots provide a user interface for a user to ask questions, request information, or generally interact with a system in a way that simulates how the user may interact with a human Chatbots interact (or conduct a “conversation”) with a user via auditory or textual methods, by providing images or video, or other means Chatbots may be implemented using a variety of computer technology, including artificial intelligence, such that they may properly respond or perform an action in response to an inquiry or command from a user. As useful as chatbots can be within a variety of systems, chatbots can be very complicated to implement, particularly for more complicated processes and use case scenarios.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is an example graphical user interface, according to some example embodiments.

FIG. 3 is a flow chart illustrating aspects of a method, according to some example embodiments.

FIG. 4 illustrates an example conversational flow generated according to some example embodiments.

FIG. 5 is a block diagram illustrating an example of a software architecture that may be installed on a machine, according to some example embodiments.

FIG. 6 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein provide for generating a conversational flow for a chatbot using system process files. A conversational flow may be in the form of a map (e.g., a tree with branches) to outline a conversation with a user for a particular system function. The conversational flow may comprise a plurality of nodes for if-else conditions, API calls, and messages that the chatbot relies upon while interacting with a user.

A system may have many system functions. In one example, a human resources system may have functions related to employee performance, salary and bonus information, vacation and other types of leave policies, benefits information, and so forth. A chatbot may be developed for each function or for each function of a subset of the functions of a system. For each system function, a conversational flow for the chatbot may be developed in the form of a map or tree structure with multiple nodes and branches for responding to a variety of input from a user. It can be appreciated that a conversational flow may be very complex based on what function the chatbot is covering.

Example embodiments provide for generating, from a static process flow file, a conversational flow for a chatbot. Example embodiments provide for receiving, by a computing system, a request to generate a conversational flow for a system function, analyzing, by the computing system, a process flow file comprising steps for the system function to determine each step in the process of the system function, and generating, by the computing system, a start node for the conversational flow for the system function. Example embodiments further provide, for each step in the process flow file, generating nodes in the conversational flow for the system function by determining, by the computing system, at least one parameter for the step, generating, by the computing system, a branch in the conversational flow for the at least one parameter including a condition node for the at least one parameter, generating, by the computing system, an application programming interface (API) node for the step, the API node to call a function using the at least one parameter and generating, by the computing system, at least one branch comprising a message node for the response returned from the function called via the API node. Example embodiments further provide for providing, by the computing system to at least one computing device, the conversational flow for the system function, the conversational flow comprising a plurality of nodes.

Example embodiments described herein provide for a number of technical benefits. For example, example embodiments provide for a more efficient and accurate system by generating the conversational flow from a process flow file for a system function. Example embodiment further increase the speed of developing a chatbot making for more efficient development processes and provides for fewer opportunities for errors to occur in the conversational flow.

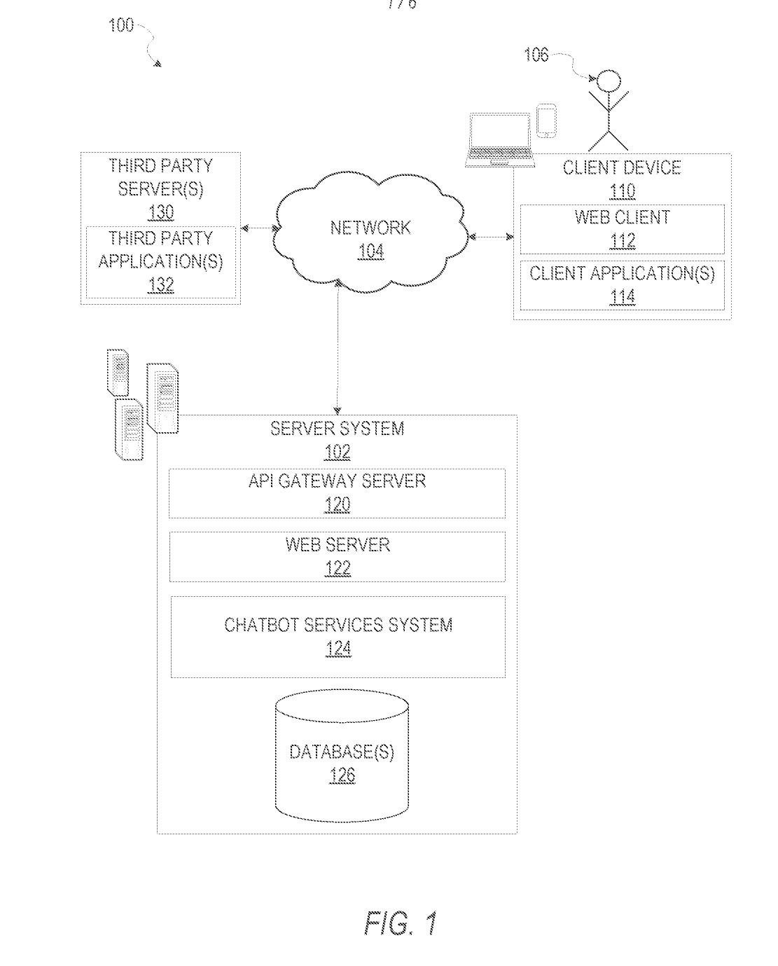

FIG. 1 is a block diagram illustrating a networked system 100, according to some example embodiments. The system 100 may include one or more client devices such as client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth. The client device 110 may be a device of a user that is used to request and receive information via a digital assistant or smart agent service, and so forth.

One or more users 106 may be a person, a machine, or other means of interacting with the client device 110. In example embodiments, the user 106 may not be part of the system 100, but may interact with the system 100 via the client device 110 or other means. For instance, the user 106 may provide input (e.g., voice, touch screen input, alphanumeric input, etc.) to the client device 110 and the input may be communicated to other entities in the system 100 (e.g., third party servers 130, server system 102, etc.) via a network 104. In this instance, the other entities in the system 100, in response to receiving the input from the user 106, may communicate information to the client device 110 via the network 104 to be presented to the user 106. In this way, she user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via well client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, messaging application, electronic mail (email) application, an e-commerce site application, a mapping or location application, a digital assistant application, a smart agent service application, a customer support application, a chatbot conversational flow generation application, and the like.

In some embodiments, one or more client applications 114 may be included in a given one of the client device 110 and configured to locally provide the user interface and at least some of the functionalities, with the client application 114 configured to communicate with other entities in the system 100 (e.g., third party servers 130, server system 102, etc.), on an as needed basis, for data and/or processing capabilities not locally available (e.g., access enterprise resource planning (ERP) or customer relationship management (CRM) data, to request data, to authenticate a user 106, to verify a method of payment, interact with smart agent services, etc.). Conversely, one or more applications 114 may not be included in the client device 110, and then the client device 110 may use its web browser to access the one or more applications hosted on other entities in the system 100 (e.g., third party servers 130, server system 102, etc.).

A server system 102 may provide server-side functionality via the network 104 (e.g., the Internet or wide area network (WAN)) to one or more third party servers 130 and/or one or more client devices 110. The server system 102 may include an application program interface (API) gateway server 120, a web server 122, and a chatbot services system 124, that may be communicatively coupled with one or more databases 126 or other form of data stores.

The one or more databases 126 may be one or more storage devices that store data related to an enterprise system, user data, and other data. The one or more databases 126 may further store information related to third party servers 130, third party applications 132, client devices 110, client applications 114, users 106, and so forth. The one or more databases 126 may include cloud-based storage, in some embodiments. The one or more databases 126 may comprise data related to various product and services, support services data, human resources data, and so forth.

The server system 102 may be a cloud computing environment, according to some example embodiments. The server system 102, and any servers associated with the server system 102, may be associated with a cloud-based application, in one example embodiment.

The chatbot services system 124 may manage resources and provide back-end support for third party servers 130, third party applications 132, client applications 114, and so forth, which may include cloud-based applications. The chatbot services system 124 may provide functionality for chatbot services related to various systems and system functions.

The system 100 may further include one or more third party servers 130. The one or more third party servers 130 may include one or more third party application(s) 132. The one or more third party application(s) 132, executing on third party server(s) 130, may interact with the server system 102 via API gateway server 120 via a programmatic interface provided by the API gateway server 120. For example, one or more of the third-party applications 132 may request and utilize information from the server system 102 via the API gateway server 120 to support one or more features or functions on a website hosted by the third party or an application hosted by the third party. The third-party website or application 132, for example, may provide various functionality that is supported by relevant functionality and data in the server system 102.

A user 106 may desire to build a chatbot for one or more system functions. For example, the user 106 may want to build a chatbot for handling employee leave requests (e.g., for sick leave, vacation, etc.). To build such a chatbot the user 106 would need to define all the conversation that is appropriate for the one or more system functions, make connections to the systems needed by the process, define logic in the conversation flow, and so forth. This is quite cumbersome, time consuming, and error prone. In addition, system functions, such as enterprises processes, may be represented as process flows for ease of understanding. Some of the common standards for such representation are eXtensible Markup Language (XML), Business Process Model and Notation (BPMN), Unified Modeling Language (UML), and Business Process Modeling Language (BMNL). These process flow files comprising steps for one or more system functions may be created as part as a business process by many entities, however, these process flows are static and may not have all of the information necessary to execute the process. A system function may comprise a human resources (HR) system function (e.g., requesting leave), an eCommerce function (e.g., requesting product information), a purchase order function (e.g., generating a purchase order), and so forth. Example embodiments provide for systems, apparatuses, and methods for generating a conversation from a static process flow.

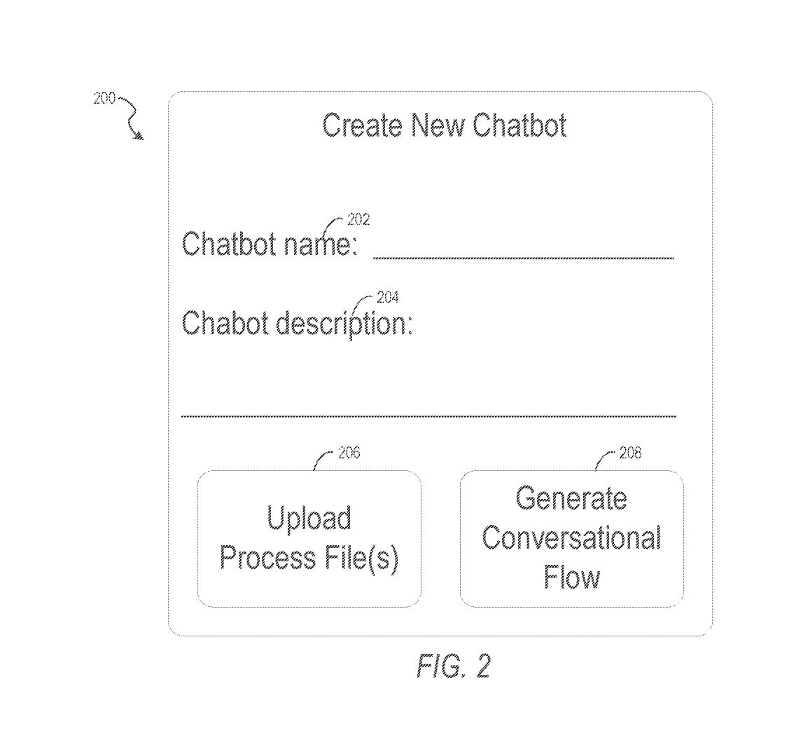

Example embodiments may provide an interface to the user (e.g., via a computing device such as client device 110), that allows the user to request that a conversational flow be generating for the system function. An example graphical user interface (GUI) 200 that may be displayed on a computing device is shown in FIG. 2. For example, the GUI 200 may request various information from the user to create a new chatbot, such as a chatbot name 202, and a chatbot description 204. The GUI 200 may also allow the user to upload one or more process files (e.g., via button 206) to be used to generate a conversational flow for the chatbot. In another example, the user may not need to upload any files but can instead specify where the files are stored in one or more systems, or use other means to identify the relevant process files. The GUI 200 may also provide a mechanism for the user to request that the conversational flow be generated based on the process file(s). For example, the GUI 200 may include a button or other mechanism (e.g., button 208) for a user to indicate (e.g., by pressing the button 208) that he wants a conversational flow to be generated. The computing device or other computing system can then generate the conversational flow (e.g., generate a conversation based on the process flow file) and provide it to the user, as described in further detail below.

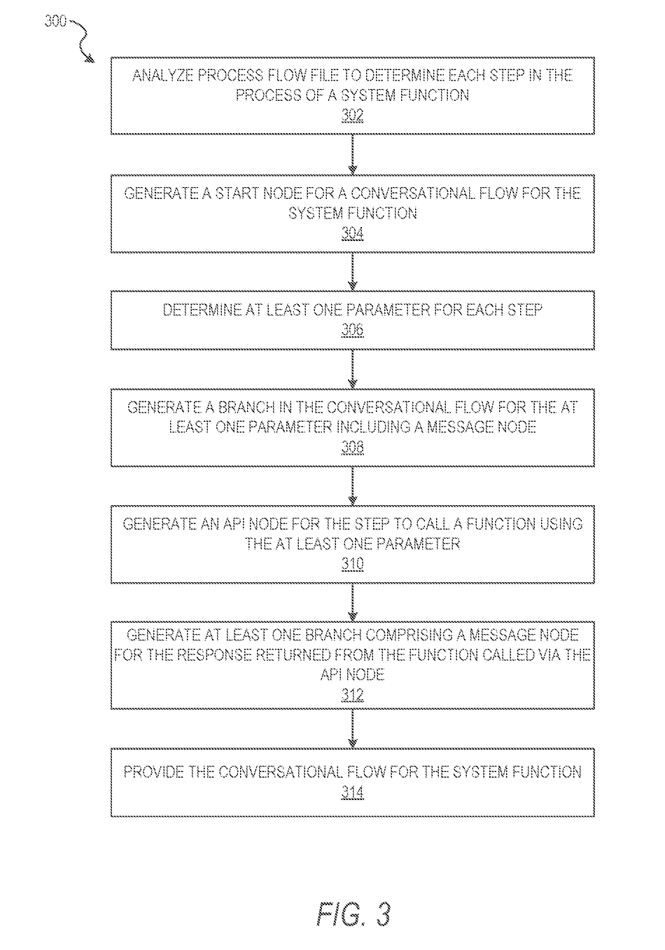

FIG. 3 is a flow chart illustrating aspects of a method 300 for generating a conversational flow, according to some example embodiments. For illustrative purposes, method 300 is described with respect to the networked system 100 of FIG. 1. It is to be understood that method 300 may be practiced with other system configurations in other embodiments. For clarity of description, the method 300 is described as being performed by a computing system (e.g., server system 102 or chatbot service system 124). In other embodiments, however, another computing device such as client device 110 may perform such a method. And in yet other embodiments, the method 300 may be performed by a combination of the computing system and computing device.

A computing system (e.g., server system 102 or chatbot services system 124) receives a request to generate a conversational flow for a system function. The request may be associated with a process flow file comprising steps for the system function. For example, the system function may be for requesting a leave request. This system function may allow an employee to request a leave (e.g., sick leave, vacation, etc.), determine whether or not the employee has sufficient balance for the leave, and create or reject the leave request.

In operation 302, the computing system analyzes the process flow file associated with the request to determine each step in the process of the system function. In one example, the computing system may parse the process flow file to find text indicating a step in the process. For example, the computing system may parse a BPMN file to determine one or more events, as shown in this portion of a BPMN file.

</startEvent>

<task completionQuantity=“1” id=“sid-9CA141CA-4465-

46F7-9654-6D6CBAC173B0” isForCompensation=“false” name=“Check
Leave Balance” startQuantity=“1”>

For example, in the above fragment, the text </startEvent> indicates a step in the process of the system function for “Check Leave Balance”.

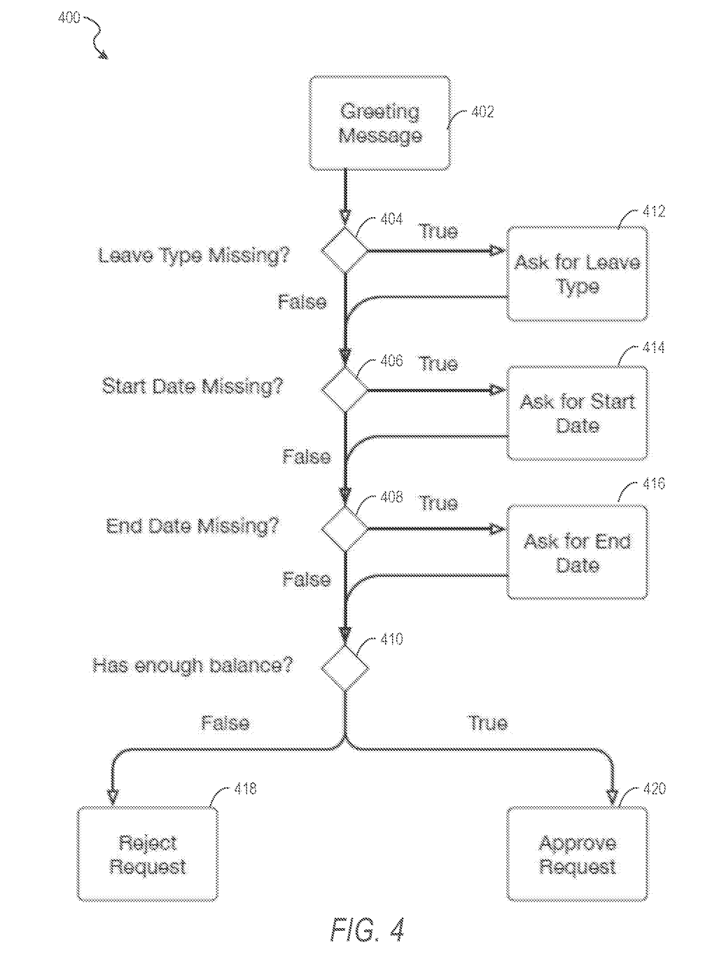

In operation 304, the computing system generates a start node for the conversational flow for the system function. For example, the computing system may generate start node 402 to begin a conversational flow 400 as shown in FIG. 4. The start node 402 may comprise a message node for a greeting or other message to an end user using the chatbot. The computing system may simply put a placeholder for the message (e.g., “Greeting Message” as shown), or may generate sample text to be used in a conversation with an end user (e.g., “How may I help you today?” or “What type of leave would you like to request?”).

Returning to FIG. 3, for each step in the process flow file, the computing system generates nodes in the conversational flow according to operations 306-314. In operation 300, the computing system determines at least one parameter for the step. Using the example portion of the XML file shown above, the first step may be to check leave balance. Checking the leave balance may entail an API call for a function to check whether or not the employee has enough leave balance to cover his request. The API call may include various parameters or variables that are needed for the function. For example, the API call may need the start date for the leave request, the end date for the leave request, and the type of leave request. In one example, the computing system may determine what these parameters are based on the XML file. For example, the XML file may specify the API call and the parameters. The computing system may parse the API information in the XML file to pull out each of the parameters needed by the function.

In another example, the XML file may not specify the API or the parameters, or may only specify that an API call is needed but not specify any parameters. In this case, the computing system may generate a branch in the conversational flow as a placeholder for a parameter that may be needed for the API call. The end user may then edit this as needed to provide the appropriate information. In another example, the computing system may have access to a variety of system functions including a function for checking a leave balance. The computing system may access the system functions (e.g., a file or table where this information is stored) to search for any of the systems function relating to a leave balance. If the system finds a system function in the system functions for a leave balance, it can analyze the function to determine the parameters needed for the function.

In operation 308, the computing system generates a branch in the conversational flow for each of the determined parameters. Each branch may include a condition node for the parameter. For example, the computing system may generate condition nodes 404, 406, and 408, as shown in FIG. 4. Each of these nodes may be if/else conditions that may lead to an associated message node 412, 414, or 416, or to the next node in the conversational flow. In this example, the parameters include leave type (e.g., type of leave), start date (for leave), and end date (for leave). The node 404 is for determining whether the end user has provided a leave type (e.g., sick leave, vacation leave, etc.). If the user has not provided a leave type, the message node 412 indicates that the chatbot ask the end user for the leave type. The computing system may populate the message node 412 with a place holder for the message indicating what information is needed, as shown in FIG. 4 as “Ask for Leave Type.” In another example, the computing system may generate example text to present to the user, such as “What type of leave would you like to request?” or “Would you like to request sick leave or vacation?”

In some cases, the parameter may be identified in the process flow file or system functions by an abbreviation or alias. For example, lv_type may be used in the process flow file or function. Accordingly, the computing system may populate the message node 412 with “Ask for lv_type.” In another example, the computing system may have access to system functions and data for requesting a leave, and may search these system functions and data to determine the actual description for “lv_type” and replace “lv_type” with “leave type” or example text to present to the user.

Node 406 is for determining whether the end user has provided a start date and node 408 is for determining whether the end user has provided an end date. Each of these nodes is also associated with a message node (nodes 414 and 416 respectively) that can be populated similar to what is described above for node 404.

In one example, the computing system may determine combinations of the parameters. For example, instead or generating a separate branch for each parameter, as described above, the computing system may generate branches for different combinations. For example, different parameters may be provided by an end user in different ways through a chatbot. Using the leave request example, an end user may provide a start date and leave type but not end date, or an end date and leave type but now start date, and so forth. Example embodiments generate the number of conversation branches that are possible based on the number of parameters. In one example, this can be done using a formula for the combination of the number of parameters (also referred to as “variables”).

In the leave example, the number of parameters is three and possible combinations are calculated using the formula ⁿCᵣ where n is the number of parameters and r is the number of parameters provided together. In the leave request example, the end user can provide all three parameters in one sentence or, two or one parameter in a sentence. Thus, the total combination is =³C₃+³C₂+³C₁=1+3+3=7. For example, all three parameters may be provided by an end user (e.g., start date, end date, type of leave). In another example, only two inputs may be provided by the end user (e.g., start date, end date or start dale, type or end date, type) in three possible ways of doing so, in this example. In another example, only one input may be provided by the end user (e.g., start date or end date or type) in three possible ways of doing so, in this example.

Thus, the computing system may generate seven possible branches for the conversational flow. For each branch, recommended text may be generated, as described above. For example, if the branch has a start date and type already provided, the computing system will generate sample text asking for the end date. Using this approach, the computing system will have all the branches filled out until the end user has provided all three inputs.

Returning to FIG. 3, in operation 310, the computing system generates an API node for the step. The API node may have a description of the decision to be made (e.g., check leave balance). The API node may call a function using the determine parameter(s). The computing system may specify which API to call in the conversational flow if the API is provided in the process flow file. For example, the process flow file may specifically provide the API to call, or it may only specify that an API call is needed, as explained above. In the latter case, the computing system may again have access to a variety of system functions including a function for checking a leave balance. The computing system may access the system functions to search for any of the system functions relating to a leave balance If the system finds a system function in the system functions for a leave balance, it can provide the function in the conversation flow. Accordingly, the API node may identify the function to be called via the API node.

Continuing with the example above, the API node may call a function to check the leave balance for the employee FIG. 4 shows an API node 410 to determine whether the employee has enough leave balance for the leave request. In one example, the API node 410 may also evaluate the response from call in the function via the API. For example, the API node 410 may determine whether the response of the leave balance function indicates that the employee has enough balance for the request (true) or does not have enough balance for the request (false). In another example, the computing system may generate a separate node to evaluate a response returned from the function called via the API node 410. This separate node may determine whether the response of the leave balance function indicates that the employee has enough balance for the request (true) or does not have enough balance for the request (false).

Returning to FIG. 3, in operation 312, the computing system generates at least one branch comprising a message node for a response from the function called via the API node. The computing system may determine how many branches to generate for a response from the function call, based on information provided in the process flow file or from the function itself. For example, the process flow file may specifically provide the parameters returned by the function called via the API, or it may only specify that an API call is needed, as explained above. In the latter case, the computing system may again have access to a variety of system functions including a function for checking a leave balance. The computing system may access the system functions lo search for any of the system functions relating to a leave balance. If the system finds a system function in the system functions for a leave balance, it can determine the parameters returned by the function.

FIG. 4 shows example branches with messages nodes 418 and 420 for responses to the function called via the API node 410. In this example, if the function returns false (e.g., not enough leave balance for the request), then the conversational flow branches to node 418 If the function returns true (e.g., enough leave balance for the request) then the conversational flow branches to node 420. The message nodes 418 and 420 may include a place holder for a message (e.g., “Reject Request” and “Approve Request” respectively), or the computing system may generate example text, such as “You do not have enough leave balance for your request” or “You only have 4 days of vacation, which is not enough for your request” or “You request for leave is approved.”

After the computing system has finished generating nodes in the conversational flow for the system function, for each step in the process flow file, the computing system provides the conversational flow for the system function to a computing device, in operation 314. The computing device may display the conversational flow diagram 400 as shown in FIG. 4. The conversation flow diagram 400 is editable by the computing device. Accordingly, a user developing the chatbot may edit the conversation flow as desired. Once the user finalizes the conversational flow, the chatbot may be put into operation and be available for use by end users (e.g., employees to request a leave).

The following examples describe various embodiments of methods, machine-readable media, and systems (e.g., machines devices, or other apparatus) discussed herein.

### EXAMPLE 1

A method comprising:

receiving, by a computing system, a request to generate a conversational flow for a system function;

analyzing, by the computing system, a process flow file comprising steps for the system function to determine each step in the process of the system function;

generating, by the computing system, a start node for the conversational flow for the system function;

for each step in the process flow file, generating nodes in the conversational flow for the system function by:
determining, by the computing system, at least one parameter for the step;
generating, by the computing system, a branch in the conversational flow for the at least one parameter including a condition node for the at least one parameter;
generating, by the computing system, an application programming interface (API) node for the step, the API node to call a function using the at least one parameter; and
generating, by the computing system, at least one branch comprising a message node for a response returned from the function called via the API node; and

providing, by the computing system to at least one computing device, the conversational flow for the system function, the conversational flow comprising a plurality of nodes.

### EXAMPLE 2

A method according to example 1, wherein determining at least one parameter comprises parsing information in the process flow file for the step to determine the step includes a function to be called and parsing the information to determine the at least one parameter for the function.

### EXAMPLE 3

A method according to any of the previous examples, wherein determining at least one parameter comprises parsing information in die process flow file for the step to determine the step includes a function to be called and accessing a system to look up the function and determine the at least one parameter for the function.

### EXAMPLE 4

A method according to any of the previous examples, wherein the message node for the at least one parameter comprises text indicating at least one parameter to request from the user.

### EXAMPLE 5

A method according to any of the previous examples, wherein the conversational flow provided to the at least one computing device is editable by the at least one computing device.

### EXAMPLE 6

A method according to any of the previous examples, wherein the API node identifies the function to be called via the API node based on information provided in the process flow file.

### EXAMPLE 7

A method according to any of the previous examples, wherein the API node identifies the function to be called via the API node, based on information obtained by accessing a database comprising a plurality of functions including the function to be called via the API node.

### EXAMPLE 8

A method according to any of the previous examples, wherein the branch in the conversational flow for the at least one parameter including a condition node for the at least one parameter, may further comprise a branch to a message node to request information for the at least one parameter.

### EXAMPLE 9

A method according to any of the previous examples, further comprising generating recommended text for the message node for the at least one parameter and the message node for the response returned from the function called via the API node.

### EXAMPLE 10

A method according to any of the previous examples, wherein after generating the API node for the step, the method comprises:

generating a node to evaluate a response returned from the function called via the API node,

### EXAMPLE 11

A method according to any of the previous examples, wherein the API node also evaluates a response returned from the function called via the API node.

### EXAMPLE 12

A computing system comprising:

a memory that stores instructions; and

at least one processor configured by the instructions to perform operations comprising:

receiving a request to generate a conversational flow for a system function,

analyzing a process flow file comprising steps for the system function to determine each step in the process of the system function;

generating, a start node for the conversational flow for the system function;

for each step in the process flow file, generating nodes in the conversational flow for the system function by:
determining at least one parameter for the step;
generating a branch in the conversational flow for the at least one parameter including a condition node for the at least one parameter;
generating an application programming interface (API) node for the step, the API node to call a function using the at least one parameter; and
generating at least one branch comprising a message node for the response returned from the function called via the API node; and

providing, to at least one computing device, the conversational flow for the system function, the conversational flow comprising a plurality of nodes

### EXAMPLE 13

A computing system according to any of the previous examples, wherein determining the at least one parameter comprises parsing information in the process flow file for the step to determine the step includes a function to be called and parsing the information to determine the at least one parameter for the function.

### EXAMPLE 14

A computing system according to any of the previous examples, wherein determining the at least one parameter comprises parsing information in the process flow file for the step to determine the step includes a function to be called and accessing a system to look up the function and determine the at least one parameter for the function.

### EXAMPLE 15

A computing system according to any of the previous examples, wherein the message node for the at least one parameter comprises text indicating the at least one parameter to request from the user.

### EXAMPLE 16

A computing system according to any of the previous examples, wherein the conversational flow provided to the at least one computing device is editable by the at least one computing device.

### EXAMPLE 17

A computing system according to any of the previous examples, wherein the API node identifies the function to be called via the API node based on information provided in the process flow file.

### EXAMPLE 18

A computing system according to any of the previous examples, wherein the API node identifies the function to be called via the API node, based on information obtained by accessing a database comprising a plurality of functions including the function to be called via the API node.

### EXAMPLE 19

A computing system according to any of the previous examples, wherein the branch in the conversational flow for the at least one parameter including a condition node for the at least one parameter, further comprises a branch to a message node to request information for the at least one parameter.

### EXAMPLE 20

A non-transitory computer-readable medium comprising instructions stored thereon that are executable by at least one processor to cause a computing device to perform operations comprising:

receiving a request to generate a conversational flow for a system function;

analyzing a process flow file comprising steps for the system function to determine each step in the process of the system function;

generating a start node for the conversational flow for the system function;

for each step in the process flow file, generating nodes in the conversational flow for the system function by:
determining at least one parameter for the step;
generating a branch in the conversational flow for the at least one parameter including a condition node for the at least one parameter;
generating an application programming interface (API) node for the step, the API node to call a function using the at least one parameter; and
generating at least one branch comprising a message node for the response returned from the function called via the API node, and
   providing, to at least one computing device, the conversational flow for the system function, the conversational flow comprising a plurality of nodes.

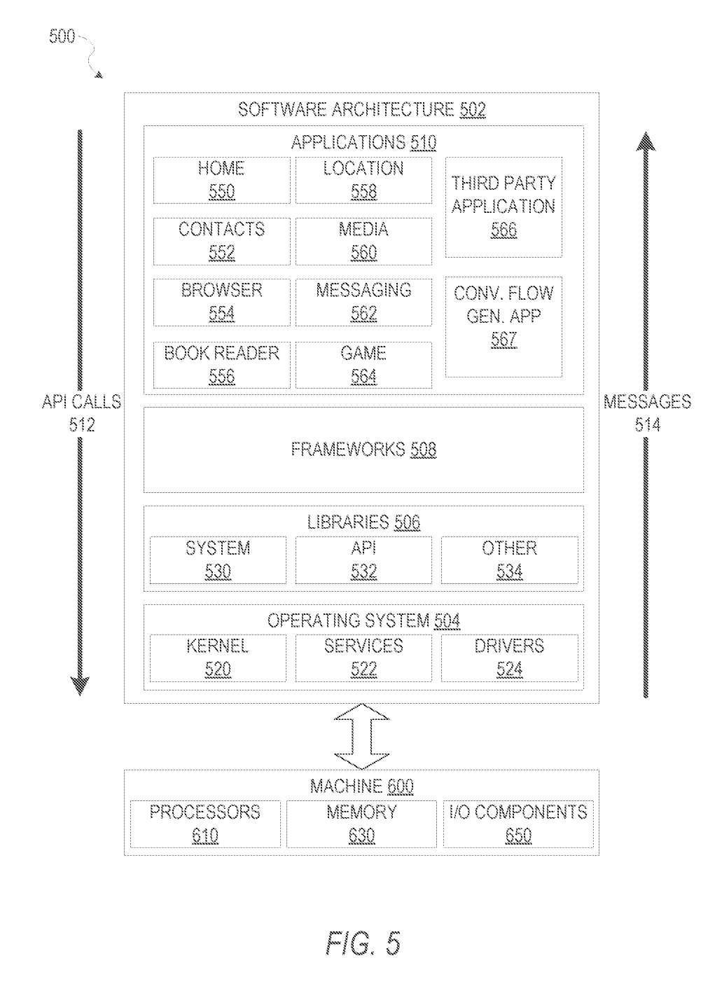

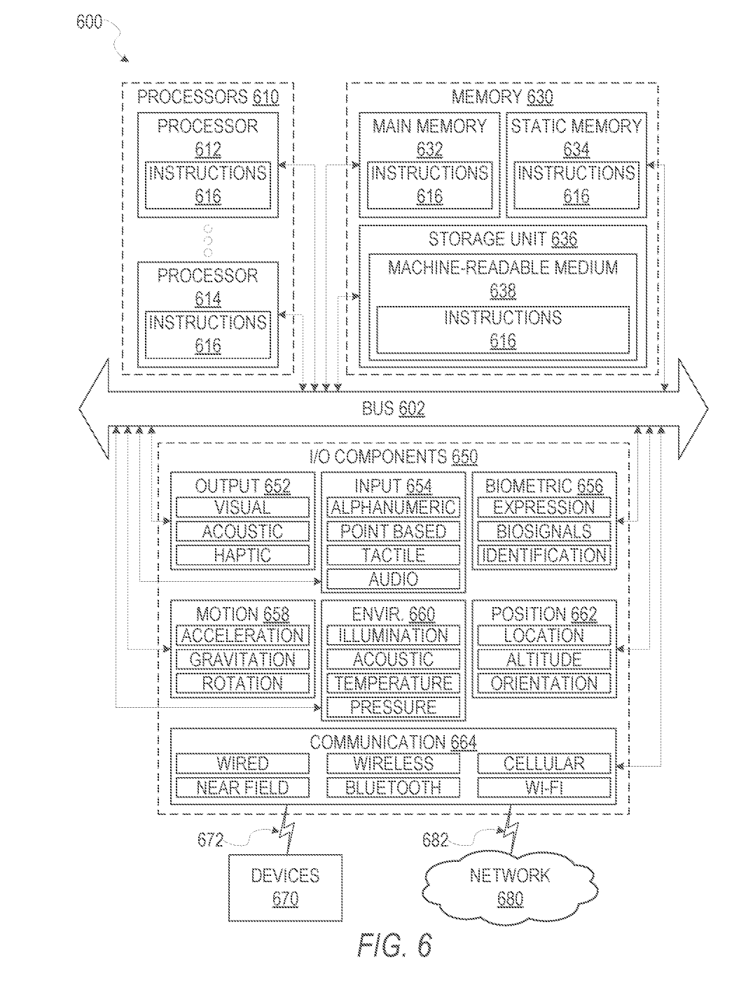

FIG. 5 is a block diagram 500 illustrating software architecture 502, which can be installed on any one or more of the devices described above. For example, in various embodiments, client devices 110 and server systems 130, 102, 120, 122, and 124 may be implemented using some or all of the elements of software architecture 502. FIG. 5 is merely a non-limiting example of a software architecture, and it will be appreciated that many other architectures can be implemented to facilitate the functionality described herein. In various embodiments, the software architecture 502 is implemented by hardware such as machine 600 of FIG. 6 that includes processors 610, memory 630, and input/output (I/O) components 650. In this example the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke application programming interface (API) calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common service for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphic user interface (GUI) functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

Some embodiments may particularly include a conversational flow generation application 567, which may be any application that requests data or other tasks to be performed by systems and servers described herein, such as server system 102, third party servers 130, and so forth. In certain embodiments, this may be a stand-alone application that operates to manage communications with a server system such as third-party servers 130 or server system 102. In other embodiments, this functionality may be integrated with another application. The conversational flow generation application 567 may request and display various data related to products and services and may provide the capability for a user 106 to input data related to the system via voice, a touch interface, a keyboard, or using a camera device of machine 600, communication with a server system via I/O components 650, and receipt and storage of object data in memory 630. Presentation of information and user inputs associated with the information may be managed by conversational flow generation application 567 using different frameworks 508, library 506 elements, or operating system 504 elements operating on a machine 600.

FIG. 6 is a block diagram illustrating components of a machine 600, according to some embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application 610, an applet, an app, or other executable code) for causing the machine 600 to perform any one or more of the methodologies discussed herein can be executed. In alternative embodiments, the machine 600 operates as a standalone device or can be coupled (e.g., networked) to other machines. In a networked deployment, the machine 600 may operate in the capacity of a server machine or system 130, 102, 120, 122, 124, and the like, or a client device 110 in a terror-client network environment, or as a peer machine in a peer-to-peer (or distributed) network environment. The machine 600 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

In various embodiments, the machine 600 comprises processors 610, memory 630, and I/O components 650, which can be configured to communicate with each other via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 612 and a processor 614 that may execute the instructions 616. The term “processor” is intended to include multi-core processors 610 that may comprise two or more independent processors 612, 614 (also referred to as “cores”) that can execute instructions 616 contemporaneously. Although FIG. 6 shows multiple processors 610, the machine 600 may include a single processor 610 with a single core, a single processor 610 with multiple cores (e.g., a multi-core processor 610), multiple processors 612, 614 with a single core, multiple processors 612, 614 with multiples cores, or any combination thereof.

The memory 630 comprises a main memory 632, a static memory 634, and a storage unit 636 accessible to the processors 610 via the bus 602, according to some embodiments. The storage unit 636 can include a machine-readable medium 638 on which are stored the instructions 616 embodying any one or more of the methodologies or functions described herein. The instructions 616 can also reside, completely or at least partially, within the main memory 632, within the static memory 634, within at least one of the processors 610 (e.g., within the processor's cache memory), or any suitable combination thereof, during execution thereof by the machine 600. Accordingly, in various embodiments, the main memory 632, the static memory 634, and the processors 610 are considered machine-readable media 638.

As used herein, the term “memory” refers to a machine-readable medium 638 able to store data temporarily or permanently and may be taken to include, but not be limited to, random-access memory (RAM), read-only memory (ROM), buffer memory, flash memory, and cache memory. While the machine-readable medium 638 is shown, in an example embodiment, to be a single medium, the term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions 616, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 650 include a wide variety of components to receive input, provide output, produce output, transmit information exchange information, capture measurements, and so on. In general, it will be appreciated that the I/O components 650 can include many other components that are not shown in FIG. 6. The I/O components 650 are grouped according to functionality merely for simplifying the following discussion, and the grouping is in no way limiting. In various example embodiments, the I/O components 650 include output components 652 and input components 654. The output components 652 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 654 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 650 include biometric components 656, motion components 658, environmental components 660, or position components 662, among a wide array of other components. For example, the biometric components 656 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 include acceleration sensor components (e.g., accelerometer), gravitation sensor components, rotation sensor components (e.g., gyroscope), and so forth. The environmental components 660 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 662 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 650 may include communication components 664 operable to couple the machine 600 to a network 680 or devices 670 via a coupling 682 and a coupling 672, respectively. For example, the communication components 664 include a network interface component or another suitable device to interface with the network 680. In further examples, communication components 664 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 670 may be another machine 600 or any of a wide variety of peripheral devices (e.g., a peripheral device coupled via a Universal Serial Bus (USB)).

Moreover, in some embodiments, the communication components 664 detect identifiers or include components operable to detect identifiers. For example, the communication components 664 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 664, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 680 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 can implement any of a variety of types of data transfer technology, such as Single Carrier Radio Transmission Technology (1xRTT), Evolution-Data Optimized (EVDO) technology, General Packet Radio Service (GPRS) technology. Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 616 are transmitted or received over the network 680 using a transmission medium via a network interface device (e.g., a network interface component included in the communication components 664) and utilizing any one of a number of well-known transfer protocols (e.g., Hypertext Transfer Protocol (HTTP)). Similarly, in other example embodiments, the instructions 616 are transmitted or received using a transmission medium via the coupling 672 (e.g., a peer-to-peer coupling) to the devices 670. The term “transmission medium” shall be taken to include any intangible medium that is capable of storing, encoding, or carrying the instructions 610 for execution by the machine 600, and includes digital or analog communications signals or other intangible media to facilitate communication of such software.

Furthermore, the machine-readable medium 638 is non-transitory (in other words, not having any transitory signals) in that it does not embody a propagating signal. However, labeling the machine-readable medium 638 “non-transitory” should not be construed to mean that the medium is incapable of movement, the medium 638 should be considered as being transportable from one physical location to another. Additionally, since the machine-readable medium 638 is tangible, the medium 638 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be perforated in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, by a computing system, a request to generate a conversational flow for a system function;
analyzing, by the computing system, a process flow file comprising steps for the system function to determine each step in the process of the system function;
generating, by the computing system, a start node for the conversational flow for the system function;
for each step in the process flow file, generating nodes in the conversational flow for the system function by:
determining, by the computing system, at least one parameter for the step;
generating, by the computing system, a branch in the conversational flow for the at least one parameter including a condition node for the at least one parameter;
generating, by the computing system, an application programming interface (API) node for the step, the API node to call a function using the at least one parameter; and
generating, by the computing system, at least one branch comprising a message node for a response returned from the function called via the API node; and
providing, by the computing system to at least one computing device, the conversational flow for the system function, the conversational flow comprising a plurality of nodes.

2. The method of claim 1, wherein determining at least one parameter comprises parsing information in the process flow file for the step to determine the step includes a function to be called and parsing the information to determine the at least one parameter for the function.

3. The method of claim 1, wherein determining at least one parameter comprises parsing information in the process flow file for the step to determine the step includes a function to be called and accessing a system to look up the function and determine the at least one parameter for the function.

4. The method of claim 1, wherein the message node for the at least one parameter comprises text indicating at least one parameter to request from the user.

5. The method of claim 1, wherein the conversational flow provided to the at least one computing device is editable by the at least one computing device.

6. The method of claim 1, wherein the API node identities the function to be called via the API node based on information provided in the process flow file.

7. The method of claim 1, wherein the API node identifies the function to be called via the API node, based on information obtained by accessing a database comprising a plurality of functions including the function to be called via the API node.

8. The method of claim 1, wherein the branch in the conversational flow for the at least one parameter including a condition node for the at least one parameter, may further comprise a branch to a message node to request information for the at least one parameter.

9. The method of claim 1, further comprising generating recommended text for the message node for the at least one parameter and the message node for the response returned from the function called via the API node.

10. The method of claim 1, wherein after generating the API node for the step, the method comprises:
generating a node to evaluate a response returned from the function called via the API node.

11. The method of claim 1, wherein the API node also evaluates a response returned from the function called via the API node.

12. A computing system comprising:
a memory that stores instructions; and
at least one processor configured by the instructions to perform operations comprising:
receiving a request to generate a conversational flow for a system function;
analyzing a process flow file comprising steps for the system function to determine each step in the process of the system function;
generating a start node for the conversational flow for the system function;
for each step in the process flow file, generating nodes in the conversational flow for the system function by:
determining at least one parameter for the step;
generating a branch in the conversational flow for the at least one parameter including a condition node for the at least one parameter;
generating an application programming interface (API) node for the step, the API node to call a function using the at least one parameter; and
generating al least one branch comprising a message node for the response returned from the function called via the API node; and
providing, to at least one computing device, the conversational flow for the system function, the conversational flow comprising a plurality of nodes.

13. The computing system of claim 12, wherein determining the at least one parameter comprises parsing information in the process flow file for the step to determine the step includes a function to be called and parsing the information to determine the at least one parameter for the function.

14. The computing system of claim 12, wherein determining the at least one parameter comprises parsing information in the process flow file for the step to determine the step includes a function to be called and accessing a system to look up the function and determine the at least one parameter for the function.

15. The computing system of claim 12, wherein the message node for the at least one parameter comprises text indicating the at least one parameter to request from the user.

16. The computing system of claim 12, wherein the conversational flow provided to the at least one computing device is editable by the at least one computing device.

17. The computing system of claim 12, wherein the API node identifies the function to be called via the API node based on information provided in the process flow file.

18. The computing system of claim 12, wherein the API node identifies the function to be called via the API node, based on information obtained by accessing a database comprising a plurality of functions including the function to be called via the API node.

19. The computing system of claim 12, wherein the branch in the conversational flow for the at least one parameter including a condition node for the at least one parameter, further comprises a branch to a message node to request information for the at least one parameter.

20. A non-transitory computer-readable medium comprising instructions stored thereon that are executable by at least one processor to cause a computing device to perform operations comprising:
receiving a request to generate a conversational flow for a system function;
analyzing a process flow file comprising steps for the system function to determine each step in the process of the system function;
generating a start node for the conversational flow for the system function;
for each step in the process flow file, generating nodes in the conversational flow for the system function by:
determining at least one parameter for the step;
generating a branch in the conversational flow for the at least one parameter including a condition node for the at least one parameter;
generating an application programming interface (API) node for the step, the API node to call a function using the at least one parameter; and
generating at least one branch comprising a message node for the response returned from the function called via the API node; and
providing, to at least one computing device, the conversational flow for the system function, the conversational flow comprising a plurality of nodes.
